(19) United States
(12) Patent Application Publication
(10) Pub. No.: US 2022/0219630 A1
(43) Pub. Date: Jul. 14, 2022

(54) VEHICLE ROOF RAIL INTEGRATED POWER OUTLET SYSTEMS

(71) Applicant: FORD GLOBAL TECHNOLOGIES, LLC, Dearborn, MI (US)

(72) Inventors: Sebastian Rosas Contreras, Mexico City (MX); Ivan Carretero Jacinto, Ecatepec de Morelos (MX); Alfredo Luna Contreras, Mexico City (MX)

(21) Appl. No.: 17/146,777

(22) Filed: Jan. 12, 2021

(51) Int. Cl. B60R 16/03; B60R 9/04; H01R 13/74

(52) U.S. Cl. CPC B60R 16/03; H02G 3/32; H01R 13/741; B60R 9/04

(57) ABSTRACT

This disclosure details roof rail power outlet systems for establishing power sources on vehicle roofs. An exemplary roof rail power outlet system may include a roof rail cover and a power outlet assembly received by a housing of the roof rail cover. The power outlet assembly may be snap connected to the housing of the roof rail cover. The power outlet assembly includes a power socket that is capable of providing a source of power at the vehicle rooftop.

### TECHNICAL FIELD

This disclosure relates to vehicle roof rails with integrated power outlet systems.

### BACKGROUND

Vehicle roofs may include roof rails that can be used as mounting points for securing cargo. Vehicle owners may desire to further leverage the space offered by the vehicle roof when enjoying outdoor activities, such as camping and tailgating activities.

### SUMMARY

A roof rail power outlet system according to an exemplary aspect of the present disclosure includes, among other things, a roof rail cover and a power outlet assembly received within a housing of the roof rail cover.

In a further non-limiting embodiment of the foregoing system, the roof rail cover includes a main body and the housing.

In a further non-limiting embodiment of either of the foregoing systems, the main body and the housing establish a unitary, integrated, single-piece structure of the roof rail cover.

In a further non-limiting embodiment of any of the foregoing systems, the power outlet assembly includes a housing, a power socket, and a cover.

In a further non-limiting embodiment of any of the foregoing systems, the housing of the power outlet assembly is snap connected to the housing of the roof rail cover.

In a further non-limiting embodiment of any of the foregoing systems, the housing of the power outlet assembly includes a slider guide received within a slot of the housing of the roof rail cover and a retention arm that engages a corresponding retention arm of the housing of the roof rail cover.

In a further non-limiting embodiment of any of the foregoing systems, a wiring harness is connected to the power outlet assembly.

In a further non-limiting embodiment of any of the foregoing systems, the wiring harness includes a connector and a wiring bundle.

In a further non-limiting embodiment of any of the foregoing systems, the wiring bundle is routed through an opening in a roof panel.

A vehicle includes a roof rail power outlet system. The roof rail power outlet system includes a roof rail cover and a power outlet assembly received within a housing of the roof rail cover.

In a further non-limiting embodiment of any of the foregoing systems, the roof rail cover is secured to an interior side of a first roof rail, and the interior side faces toward a centerline of the vehicle.

In a further non-limiting embodiment of any of the foregoing systems, a second roof rail power outlet system includes a second roof rail, a second roof rail cover, and a second power outlet system.

A roof rail power outlet system according to another exemplary aspect of the present disclosure includes, among other things, a roof rail, a roof rail cover secured to the roof rail, and a power outlet assembly connected to an integrated housing of the roof rail cover.

In a further non-limiting embodiment of the foregoing system, the roof rail is mounted to a roof panel of a vehicle roof.

In a further non-limiting embodiment of either of the foregoing systems, a wiring harness includes a connector connected to the power outlet assembly and wiring bundle routed through an opening in the roof panel.

In a further non-limiting embodiment of any of the foregoing systems, a housing of the power outlet assembly includes a slider guide received within a slot of the integrated housing of the roof rail cover.

In a further non-limiting embodiment of any of the foregoing systems, a retention arm of a housing of the power outlet system engages a corresponding retention arm of the integrated housing of the roof rail cover.

In a further non-limiting embodiment of any of the foregoing systems, the roof rail cover is secured to an interior side of the roof rail.

In a further non-limiting embodiment of any of the foregoing systems, the integrated housing protrudes from an exterior surface of a main body of the roof rail cover.

In a further non-limiting embodiment of any of the foregoing systems, the roof rail cover is secured to a rear portion of the roof rail.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 illustrates select portions of a vehicle equipped with roof rails.

FIG. 2 schematically illustrates select portions of another vehicle.

FIG. 3 is a blown up view of a roof rail power outlet system of the vehicle of FIG. 1.

FIG. 4 illustrates an open position of the roof rail power outlet system of FIG. 3.

FIG. 5 is an exploded view of the roof rail power outlet system of FIG. 3.

FIG. 6 is a cross-sectional view through section 6-6 of FIG. 4.

FIG. 7 illustrates an exemplary connection between a power outlet assembly and a roof rail cover of a roof rail power outlet system.

FIG. 8 schematically illustrates an exemplary use of a vehicle roof rail power outlet system.

### DETAILED DESCRIPTION

This disclosure details roof rail power outlet systems for establishing power sources on vehicle roofs. An exemplary roof rail power outlet system may include a roof rail cover and a power outlet assembly received by a housing of the roof rail cover. The power outlet assembly may be snap connected to the housing of the roof rail cover. The power outlet assembly includes a power socket that is capable of providing a source of power at the vehicle rooftop. These and other features of this disclosure are described in greater detail in the following paragraphs of this detailed description.

Figure illustrates a motor vehicle 10. In an embodiment, the vehicle 10 is a sport utility vehicle (SUV). However, the vehicle 10 could alternatively be configured as a car, a truck, a van, or any other type of vehicle within the scope of this disclosure. The vehicle 10 could also be a conventional motor vehicle, a battery powered hybrid or electric vehicle, or an autonomous vehicle (i.e., a driverless vehicle).

Although a specific component relationship is illustrated in the figures of this disclosure, the illustrations are not intended to limit this disclosure. In other words, the placement and orientation of the various components of the vehicle 10 are shown schematically and could vary within the scope of this disclosure. In addition, the various figures accompanying this disclosure are not necessarily drawn to scale, and some features may be exaggerated or minimized to emphasize certain details of a particular component.

The vehicle 10 includes a roof 12 that establishes an upper barrier surface for enclosing a passenger cabin 14 of the vehicle 10. The roof 12 may additionally establish an upper cargo space for storing and hauling cargo atop the vehicle 10. For example, the vehicle 10 may include a pair of roof rails 16 that are mounted to a roof panel 15 of the roof 12 and extend longitudinally along opposite sides of the roof 12. One or more cross bars (not shown) may connect between the opposing roof rails 16. The roof rails 16 and cross bars may establish a roof rack system for securing cargo on the roof 12.

An owner/user of the vehicle 10 may desire to leverage the space afforded by the roof 12 for additional purposes beyond cargo storage and transport. As an example, the vehicle owner/user may desire to utilize the vehicle 10 as a social gathering spot during outdoor activities (e.g., roof camping, roof tailgating, etc.). This disclosure therefore describes roof rail integrated power outlet systems for establishing one or more power sources at the roof 12, thereby providing roof-integrated features for enhancing the user experience during the outdoor activities.

Referring now to FIGS. 1 and 3-4, the vehicle 10 may include a power outlet systems 18. One of the roof rails 16 may be part of the power outlet system 18. In the illustrated embodiment, the power outlet system 18 is integrated with a rear portion 20 of the roof rail 16 that is associated with the driver's side of the vehicle 10. The rear portion 20 is closer to a rear end of the vehicle 10.

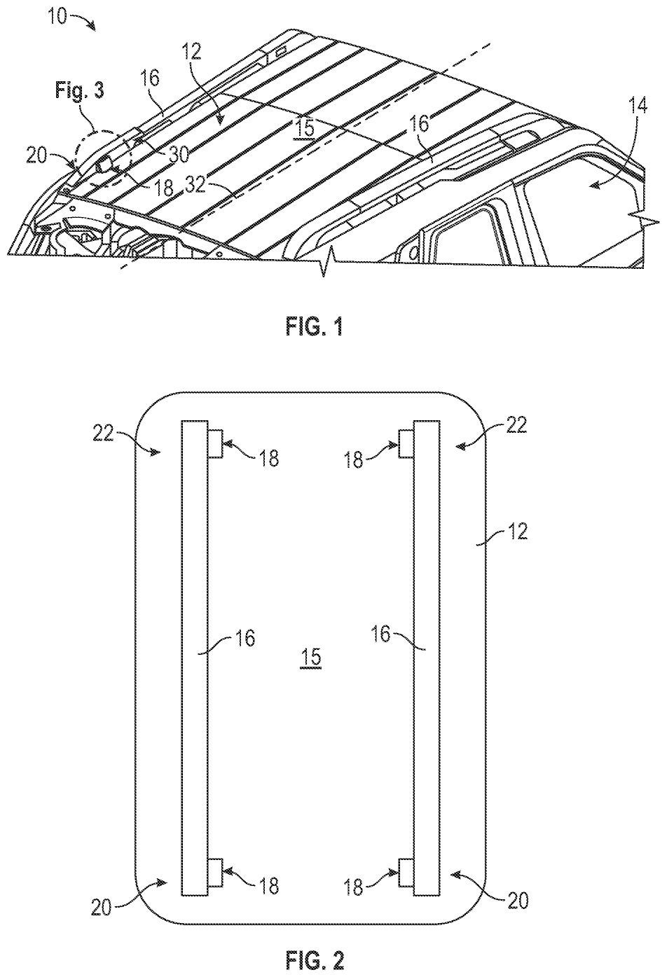

In another embodiment, each roof rail 16 could be part of two power outlet systems 18, with one power outlet system 18 being located at both a front portion 22 and a rear portion 20 of each of the roof rails 16 (see, e.g., FIG. 2). Other configurations are further contemplated within this disclosure. It should thus be understood that the vehicle 10 could be equipped with one or more power outlet systems 18.

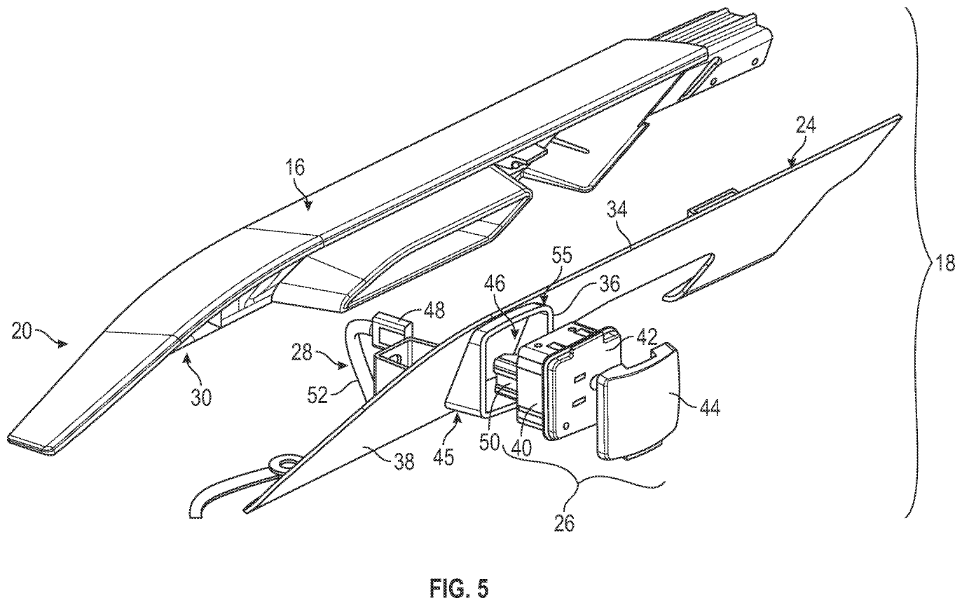

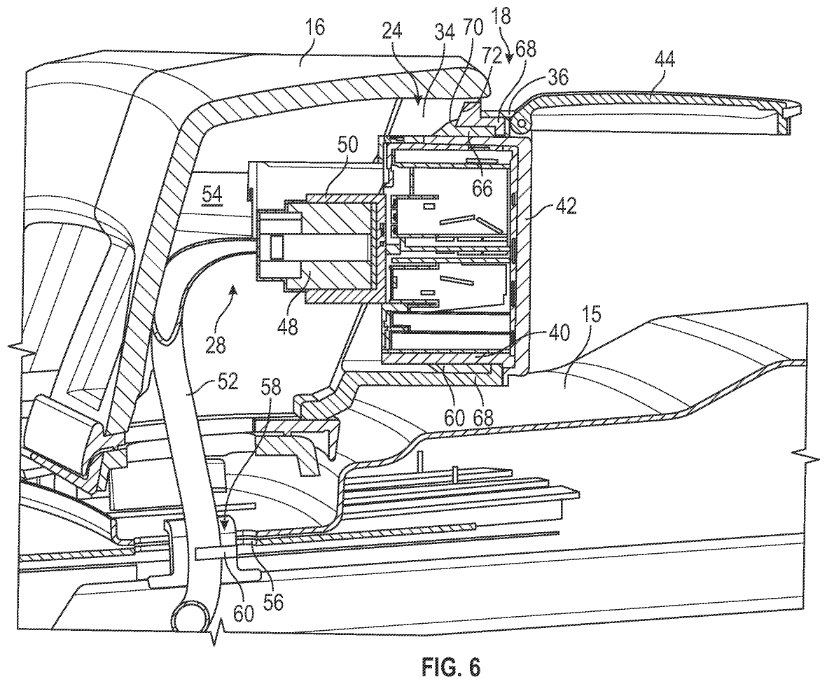

FIGS. 5-6 illustrate an exemplary roof rail power outlet system 18 for a vehicle, such as the vehicle 10 of FIG. 1, for example. The power outlet system 18 may include a roof rail 16, a roof rail cover 24, a power outlet assembly 26, and a wiring harness 28.

The roof rail cover 24 may be secured to an interior side 30 of the roof rail 16 for concealing various internal structures associated with the roof rail 16. The interior side 30 of the roof rail 16 may face in a direction toward a centerline 32 (see FIG. 1) of the vehicle 10. The interior side 30 may sometimes be referred to as the “B-side” of the roof rail 16.

The roof rail cover 24 may include a main body 34 and a housing 36 that protrudes from an exterior surface 38 of the main body 34. In an embodiment, the housing 36 is an integrated feature that is integrally formed with the main body 34. The main body 34 and the housing 36 therefore establish a unitary, integrated, single-piece structure of the roof rail cover 24. In another embodiment, a lower section 45 of the housing 36 protrudes a greater distance from the exterior surface 38 than an upper section 55 of the housing 36 (best shown in FIG. 5).

The power outlet assembly 26 of the power outlet system 18 may include a housing 40, a power socket 42, and a cover 44. The power socket 42 may be secured to the housing 40 and may embody any socket type (e.g., Type A or B for North America, Type E or F for Europe, Type C for South America, etc.). The specific configuration of the power socket 42 is not intended to limit this disclosure.

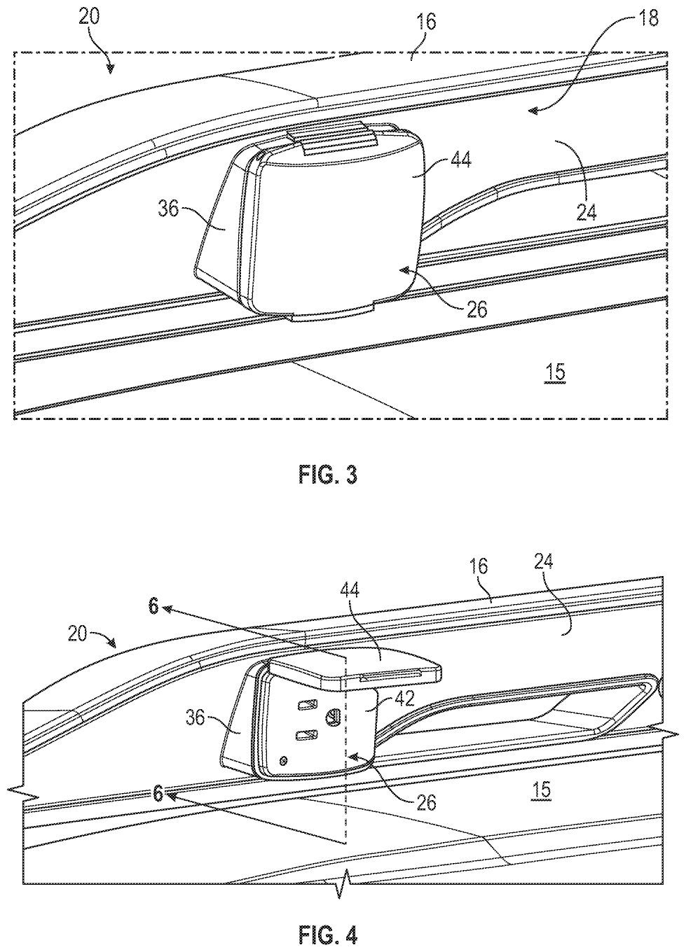

The cover 44 may be movably secured to either the housing 40 or the power socket 42 of the power outlet assembly 26. The cover 44 may be manually pivoted between closed and open positions to either conceal the power socket 42 (see FIG. 3) or expose the power socket 42 for use (see FIGS. 4 and 6).

The housing 36 of the roof rail cover 24 may establish an opening 46 that is sized and shaped to receive the housing 40 of the power outlet assembly 26. As discussed in greater detail below, the housing 40 of the power outlet assembly 26 may be snap connected to the housing 36 of the roof rail cover 24. When connected to the housing 36, the power outlet assembly 26 essentially becomes a sub-assembly of the roof rail 16 and is located on the B-side, rear portion 20 of the roof rail 16.

The wiring harness 28 may electrically connect the power outlet assembly 26 to a power supply located inside the vehicle 10. The power socket 42 may be powered by the power supply for establishing the power outlet system 18 as a rooftop power source. When powered, the power socket 42 of the power outlet assembly 26 can provide alternating current power at a voltage level (e.g., 120 volts, 220 volts, etc.) suitable for powering various electronic devices on top of the vehicle 10 when using the roof 12 for camping or other outdoor activities.

The wiring harness 28 may include a connector 48 that connects to a corresponding connector 50 of the power outlet assembly 26. A wiring branch 52 of the wiring harness 28 may be routed through an interior region 54 (see FIG. 6) of the roof rail 16 and then through an opening 56 formed through the roof panel 15 for connection to the power supply.

One or more wiring retainers 58 may be utilized for routing and securing the wiring branch 52 between the power outlet assembly 26 and the power supply. In an embodiment, the wiring retainer 58 is clipped to a surface of the roof panel 15 that surrounds the opening 56 and includes a strap 60 for tying down portions of the wiring branch 52.

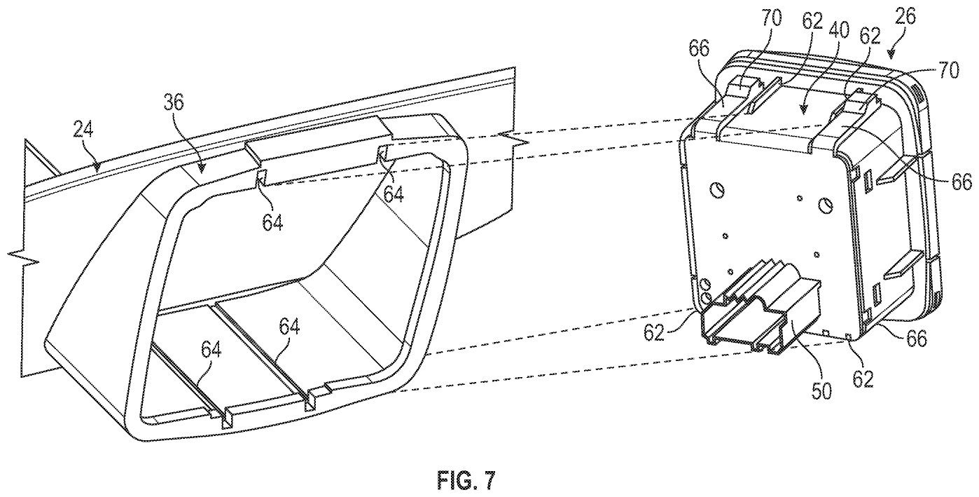

FIGS. 6-7 illustrate exemplary connection features for snap connecting the housing 40 of the power outlet assembly 26 to the housing 36 of the roof rail cover 24. In an embodiment, the housing 40 includes slider guides 62 that may be received within slots 64 of the housing 36. Once the housing 40 is pushed far enough into the housing 36, retention arms 66 of the housing 40 may engage corresponding retention arms 68 of the housing 36. In an embodiment, a protruding ledge 70 of each retention arm 68 may engage an engagement surface 72 of each retention arm 68 for snap connecting the housing 40 to the housing 36.

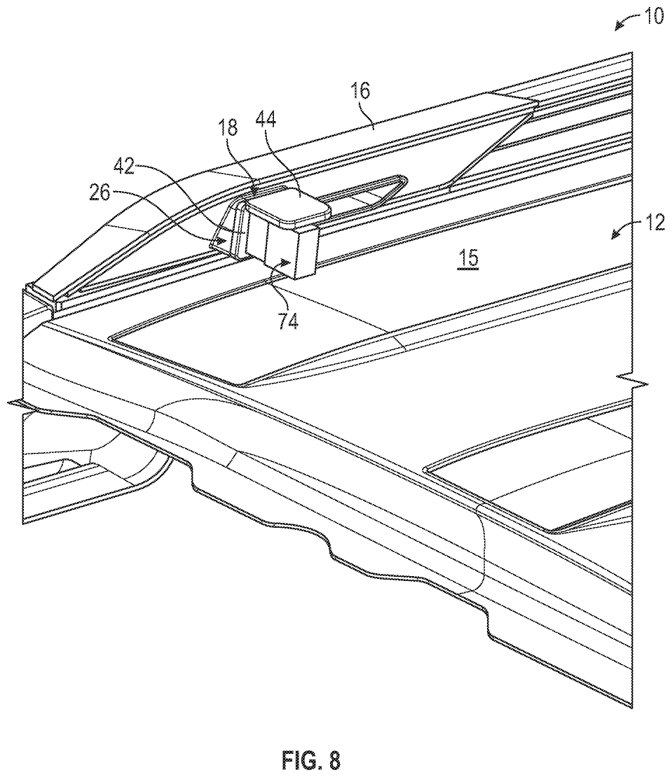

FIG. 8 schematically illustrates an exemplary use of the roof rail power outlet system 18 described above. With the cover 44 of the power outlet assembly 26 positioned in the open position, a user may insert (i.e., plug) an electrical device 74 into the power socket 42. The electrical device 74 may thereby be powered by the power outlet system 18, which is conveniently packaged near the user when the roof 12 is being used for roof camping or some other outdoor activity.

The electrical device 74 could be any electrical device having a power plug that is compatible with the power socket 42. Non-limiting examples of electrical devices that could be powered by the power outlet system 18 include but are not limited to a smart device (e.g., smart phone, tablet, computer, etc.), an entertainment console, a charger, a fan, a heater, an air conditioning device, a lighting device (e.g., light bar, fog lamp, etc.), a radio, etc.

The roof rail power outlet systems described herein allow vehicle owners to leverage the space of the vehicle roof when enjoying outdoor activities, such as roof camping and tailgating. The exemplary roof rail power outlet systems are integratable with vehicle roof rails, easy to assemble, packaged at convenient roof locations, and interchangeable depending on the market where the power socket will be used.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A roof rail power outlet system, comprising:
a roof rail cover; and
a power outlet assembly received within a housing of the roof rail cover.

2. The system as recited in claim 1, wherein the roof rail cover includes a main body and the housing.

3. The system as recited in claim 2, wherein the main body and the housing establish a unitary, integrated, single-piece structure of the roof rail cover.

4. The system as recited in claim 1, wherein the power outlet assembly includes a housing, a power socket, and a cover.

5. The system as recited in claim 4, wherein the housing of the power outlet assembly is snap connected to the housing of the roof rail cover.

6. The system as recited in claim 5, wherein the housing of the power outlet assembly includes a slider guide received within a slot of the housing of the roof rail cover and a retention arm that engages a corresponding retention arm of the housing of the roof rail cover.

7. The system as recited in claim 1, comprising a wiring harness connected to the power outlet assembly.

8. The system as recited in claim 7, wherein the wiring harness includes a connector and a wiring bundle.

9. The system as recited in claim 8, wherein the wiring bundle is routed through an opening in a roof panel.

10. A vehicle comprising the roof rail power outlet system of claim 1.

11. The vehicle as recited in claim 10, wherein the roof rail cover is secured to an interior side of a first roof rail, and further wherein the interior side faces toward a centerline of the vehicle.

12. The vehicle as recited in claim 11, comprising a second roof rail power outlet system including a second roof rail, a second roof rail cover, and a second power outlet system.

13. A roof rail power outlet system, comprising:
a roof rail;
a roof rail cover secured to the roof rail; and
a power outlet assembly connected to an integrated housing of the roof rail cover.

14. The system as recited in claim 13, wherein the roof rail is mounted to a roof panel of a vehicle roof.

15. The system as recited in claim 14, comprising a wiring harness including a connector connected to the power outlet assembly and wiring bundle routed through an opening in the roof panel.

16. The system as recited in claim 13, wherein a housing of the power outlet assembly includes a slider guide received within a slot of the integrated housing of the roof rail cover.

17. The system as recited in claim 13, wherein a retention arm of a housing of the power outlet system engages a corresponding retention arm of the integrated housing of the roof rail cover.

18. The system as recited in claim 13, wherein the roof rail cover is secured to an interior side of the roof rail.

19. The system as recited in claim 18, wherein the integrated housing protrudes from an exterior surface of a main body of the roof rail cover.

20. The system as recited in claim 13, wherein the roof rail cover is secured to a rear portion of the roof rail.
